(19) United States
(12) Patent Application Publication
(10) Pub. No.: US 2006/0132093 A1
(43) Pub. Date: Jun. 22, 2006

(54) Battery pack leakage cut-off

(76) Inventor: Don J. Nguyen, Portland, OR (US)

Correspondence Address: INTEL CORPORATION, P.O. BOX 5326, SANTA CLARA, CA, 95056-5326, US

(21) Appl. No.: 11/022,484

(22) Filed: Dec. 22, 2004

(51) Int. Cl. H02J 7/00

(52) U.S. Cl. 320/132

(57) ABSTRACT

Embodiments of the present invention can reduce or eliminate problems with battery pack leakage by monitoring a power level of a battery pack and cutting-off power to control circuitry in the battery pack when the power level reaches a certain threshold.

### FIELD OF THE INVENTION

The present invention relates to the field of power systems. More specifically, the present invention relates to cutting off leakage in a battery pack.

### BACKGROUND

Notebook computers, and various other electronic devices, often use battery power when AC power is not available. Batteries often include chemical compositions that can be dangerous. For example, some battery chemistries may explode or burn violently if they are over-charged or get too hot. Therefore, many electronic devices use “smart” battery packs that include fail-safe mechanisms, such as control circuitry that can monitor the operating condition of a battery and disable the battery if unsafe conditions are detected.

The circuitry in these battery packs usually consumes a certain amount of power. So, even when a battery pack is not in use, the batteries may slowly discharge. This is often referred to as battery pack leakage. For example, if control circuitry consumes 50 milli-watts in a battery pack having a 50 watt-hour charge, the leakage can completely discharge the battery pack in about 1000 hours, or about 1.5 months.

With some battery chemistries, leakage is merely an annoyance. For example, Lithium-ion batteries can usually be recharged even after being fully discharged. A Lithium-ion battery may require extensive recharging once it has been completed discharged, but it will probably be otherwise undamaged. For other battery chemistries, especially some newer, higher-capacity chemistries, leakage can be fatal. For example, a Thin-Film Solid State battery cell usually cannot be recharged once it has been discharged below about 1.2 volts per cell.

### BRIEF DESCRIPTION OF DRAWINGS

Examples of the present invention are illustrated in the accompanying drawings. The accompanying drawings, however, do not limit the scope of the present invention. Similar references in the drawings indicate similar elements.

FIG. 1 illustrates one embodiment of control circuitry in a battery pack.

FIG. 2 illustrates one embodiment of leakage cut-off circuitry in a battery pack.

FIG. 3 illustrates one embodiment of a notebook computer that can use a battery pack.

### DETAILED DESCRIPTION OF THE INVENTION

In the following detailed description, numerous specific details are set forth in order to provide a thorough understanding of the present invention. However, those skilled in the art will understand that the present invention may be practiced without these specific details, that the present invention is not limited to the depicted embodiments, and that the present invention may be practiced in a variety of alternative embodiments. In other instances, well known methods, procedures, components, and circuits have not been described in detail. Parts of the description will be presented using terminology commonly employed by those skilled in the art to convey the substance of their work to others skilled in the art. Repeated usage of the phrase “in one embodiment” does not necessarily refer to the same embodiment, although it may.

Embodiments of the present invention can reduce or eliminate problems with battery pack leakage by monitoring the voltage level of a battery pack and cutting-off power to control circuitry in the battery pack when the voltage level reaches a certain threshold.

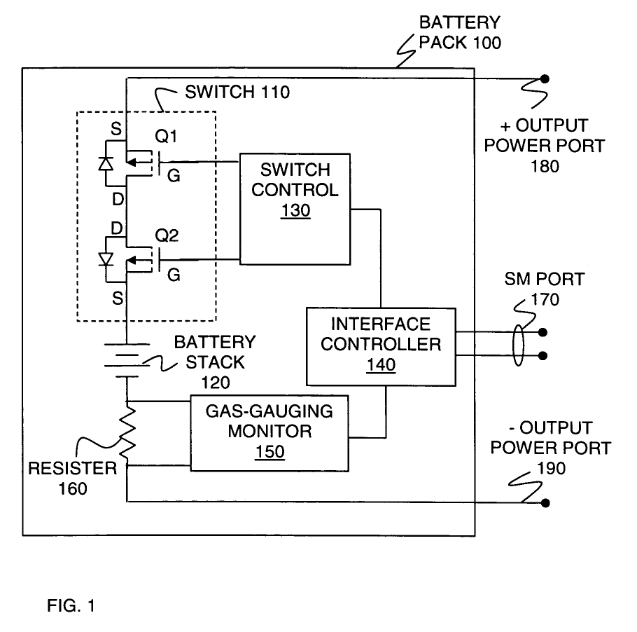

FIG. 1 illustrates one embodiment of a functional block diagram representing a smart battery pack 100. Battery pack 100 includes a battery stack 120. Battery stack 120 may include one or more battery cells. Any number of battery chemistries can be used, including Lithium-ion and Thin-Film Solid State. The battery cells can be arranged in parallel, series, or both, depending on how much voltage and current are needed across the output power ports 180 and 190.

Battery pack 100 also includes various control circuitry elements 110, 130, 140, 150, 160, and 170. Switch 110 can disable the battery pack by disconnecting stack 120 from power port 180. Switch control 130 can generate the appropriate signals to open or close switch 110.

Monitor 150 can monitor one or more characteristics of battery stack 120. In the illustrated embodiment, monitor 150 comprises a gas-gauging monitor, which can use series resister 160 to measure charge going into the battery stack during charging and coming out of the battery stack when providing power. Other embodiments may use any of a number of monitoring devices, and may monitor different or additional battery characteristics.

Interface controller 140 can receive input from monitor 150. If an unsafe condition is detected, interface controller 140 can instruct switch control 130 to disable the battery stack. Interface controller 140 is also coupled to system management (SM) port 170. When battery pack 100 is used to power a device, such as a notebook computer, interface controller 140 can communicate with the device through SM port 170. For instance, interface controller 140 may report information from monitor 150 about the condition of the battery stack. Interface controller 140 may also receive instructions through SM port 170 to enable or disable the battery pack.

The control circuitry in battery pack 100 can consume energy even when the battery pack is not in use. If this leakage is left unchecked, it could completely discharge battery stack 120 over time. Depending on the battery chemistry being used, completely discharging the battery stack may result in an excessively long recharge period, or it may fatally damage the battery cells.

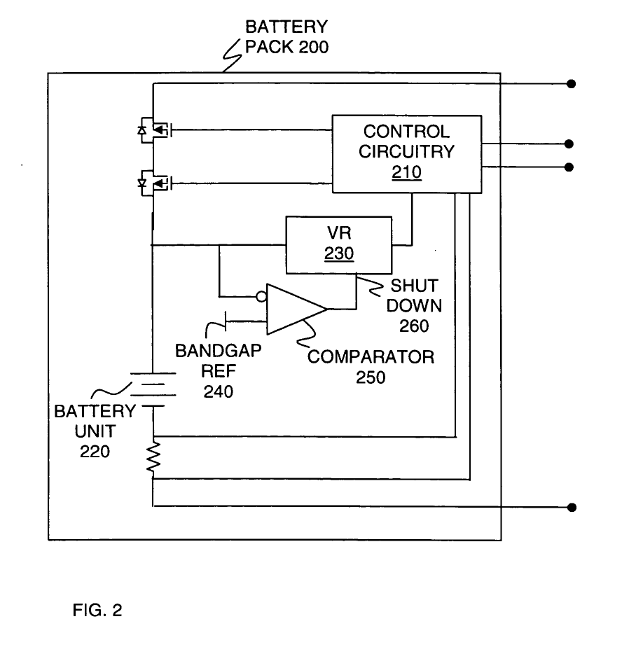

FIG. 2 illustrates one embodiment of leakage cut-off circuitry in a smart battery pack 200. Control circuitry 210 can be powered by battery unit 220 through a voltage regulator 230. The cut-off circuitry can include a voltage comparator 250 and a voltage reference circuit 240. In the illustrated embodiment, reference circuit 240 comprises a bandgap voltage circuit which can provide a relatively constant voltage level using a wide range of input voltages. Other embodiments may use any of a number of circuits to provide a threshold for the cut-off circuitry.

Comparator 250 can compare the reference voltage to the voltage level of the battery unit 220. When and if the battery voltage drops to or below the threshold set by the reference voltage, comparator 250 can assert a shut-down signal 260 to cut-off power to the control circuitry 210 by turning off VR 230. By cutting power to the control circuitry, the battery leakage can be substantially reduced or eliminated.

In one embodiment, the threshold voltage for cutting power to the control circuitry may be, for instance, just below the minimum voltage needed to power a device. This could reduce recharging time after prolonged inactivity. For example, a notebook computer may be able to operate on battery power between 13 volts and 6 volts. Battery pack 200 may provide 12.6 volts to the notebook computer when fully charged. When the battery pack is discharged down to 6 volts, the notebook computer may shut down. In which case, the threshold voltage for the leakage cut-off circuitry may be just below 6 volts, at 5.8 volts for instance. Without significant leakage during an extended period of inactively, the voltage level may remain higher than it otherwise would, potentially reducing the amount of time needed when the battery is eventually recharged.

In another embodiment, the threshold voltage for cutting power to the control circuitry may be, for instance, just above a critical voltage for the battery cells. For instance, it may not be possible to recharge a Thin-Film Solid State battery cell if the voltage drops below 1.2 volts. In which case, the threshold voltage for a battery stack including three Thin-Film Solid State cells in series could be set at 3.6 volts, or 1.2 volts times the number of series battery cells.

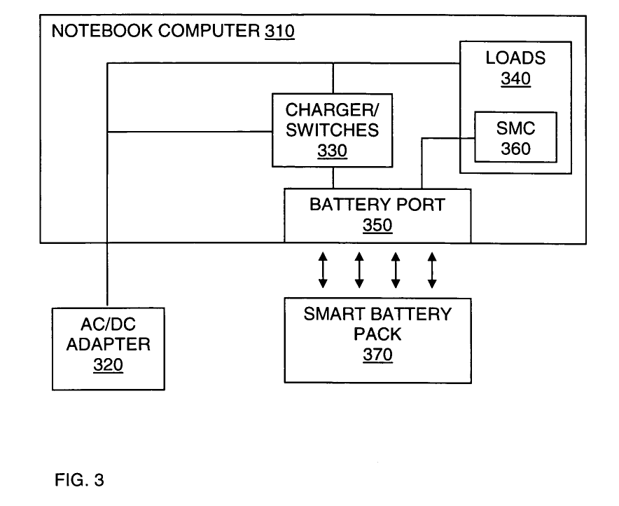

FIG. 3 illustrates a functional block diagram of a notebook computer 310 in which embodiments of the present invention can be used. Computer 310 includes a number of electrical loads 340. Loads 340 could include, for instance, a processor, memory devices, a display, and the like. The loads can be powered by AC/DC adapter 320 or smart battery pack 370. Battery pack 370 can also be recharged by adapter 320. Computer 310 can use circuitry 330 to switch among the various power sources and recharging configurations.

For instance, if adapter 320 is unplugged, and battery pack 370 is sufficiently charged, circuitry 330 can switch loads 340 over to battery pack 370. When adapter 320 is plugged in again, circuitry 330 can switch loads 340 back to adapter 320, and may also be able to simultaneously recharge battery pack 370.

Computer 310 also includes a system management controller (SMC) 360. SMC 360 can be used to communicate with the control circuitry in battery pack 370. For instance, SMC controller 360 may instruct the control circuitry to disable the battery pack in certain situations, such as when the battery voltage drops below the minimum voltage required by the computer.

The illustrated embodiment also includes a battery port 350 so that battery pack 370 can be removed, re-inserted, or replaced. In other embodiments, the battery pack may be fixed component within the computer.

Although the present invention has been primarily described in the context of battery packs for notebook computers, embodiments of the present invention can be used in a variety of electronic devices such as video cameras, hand-held computing devices, cellular phones, computer tablets, etc.

FIGS. 1-3 illustrate a number of implementation-specific details. Other embodiments may not include all of the illustrated elements, may include additional elements, may arrange elements in a different order, may combine one or more elements, and the like. Furthermore, any of a number of alternate hardware circuits can be used to perform the various functions described above.

Thus, battery pack leakage cut-off is described. Whereas many alterations and modifications of the present invention will be comprehended by a person skilled in the art after having read the foregoing description, it is to be understood that the particular embodiments shown and described by way of illustration are in no way intended to be considered limiting. Therefore, references to details of particular embodiments are not intended to limit the scope of the claims.

What is claimed is:

1. A battery pack comprising:
a battery unit;
control circuitry to be powered by the battery unit; and
a cut-off unit coupled to the battery unit and the control circuitry, said cut-off unit to monitor a power level of the battery unit and to cut-off power to the control circuitry when the power level is below a particular threshold.

2. The battery pack of claim 1 wherein the battery unit comprises one or more thin-film solid state battery cells.

3. The battery pack of claim 1 wherein the control circuitry comprises:
switch circuitry to selectively decouple the battery unit from a power port of the battery pack;
monitor circuitry to monitor at least one characteristic of the battery unit and to provide a signal based at least in part on the characteristic(s); and
an interface controller to control the switch circuitry based at least in part on the signal from the monitor circuitry.

4. The battery pack of claim 3 further comprising:
a system management port coupled to the interface controller, wherein the interface controller is to control the switch circuitry based also on input from the system management port.

5. The battery pack of claim 1 wherein the cut-off unit comprises:
a reference voltage circuit, wherein the particular threshold is a reference voltage generated by the reference voltage circuit; and
a voltage comparator to compare a voltage level of the battery unit to the reference voltage and to provide a shut-down signal to the control circuitry based on the comparison.

6. The battery pack of claim 5 wherein the reference voltage circuit comprises a bandgap circuit.

7. The battery pack of claim 5 wherein the reference voltage comprises 1.2 volts times a number of series battery cells in the battery unit.

8. The battery pack of claim 5 wherein the control circuitry comprises a voltage regulator to generate power for the control circuitry when the shut-down signal is unasserted.

9. A method comprising:
monitoring a power level of a battery unit in a battery pack, said battery pack containing control circuitry that is powered by the battery unit; and
cutting-off power to the control circuitry when the power level is below a particular threshold.

10. The method of claim 9 wherein monitoring the power level of the battery pack comprises:
generating a reference voltage as the particular threshold; and
comparing a voltage level of the battery unit to the reference voltage.

11. The method of claim 10 wherein cutting-off power to the control circuitry comprises:
providing a shut-down signal to the control circuitry based on comparing the voltage level of the battery unit to the reference voltage.

12. A system comprising:
a mobile computer; and
a battery pack, said battery pack including
a battery unit;
control circuitry to be powered by the battery unit; and
a cut-off unit coupled to the battery unit and the control circuitry, said cut-off unit to monitor a power level of the battery unit and cut-off power to the control circuitry when the power level is below a particular threshold.

13. The system of claim 12 wherein the battery unit comprises one or more thin-film solid state battery cells.

14. The system of claim 12 wherein the cut-off unit comprises:
a reference voltage circuit, wherein the particular threshold is a reference voltage generated by the reference voltage circuit; and
a voltage comparator to compare a voltage level of the battery unit to the reference voltage and provide a shut-down signal to the control circuitry based on the comparison.

15. The system of claim 14 wherein the reference voltage circuit comprises a bandgap circuit.

16. The system of claim 14 wherein the reference voltage comprises 1.2 volts times a number of series battery cells in the battery unit.

17. The system of claim 14 wherein the control circuitry comprises a voltage regulator to generate power for the control circuitry when the shut-down signal is unasserted.
